(19) United States
(12) Patent Application Publication
(10) Pub. No.: US 2010/0073080 A1
(43) Pub. Date: Mar. 25, 2010

(54) AUTOMATIC GAIN CONTROL CIRCUIT AND METHOD FOR AUTOMATIC GAIN CONTROL

(75) Inventor: Yo An Jung, Gyeonggi-do (KR)

Correspondence Address: BLANK ROME LLP, WATERGATE, 600 NEW HAMPSHIRE AVENUE, N.W., WASHINGTON, DC, 20037, US

(73) Assignee: Posdata Co., Ltd., Seongnami-si (KR)

(21) Appl. No.: 12/516,741

(22) PCT Filed: Nov. 23, 2007
(86) PCT No.: PCT/KR07/05958

§ 371 Date: May 28, 2009

(30) Foreign Application Priority Data
Nov. 28, 2006 (KR) 10-2006-0118333

(51) Int. Cl. H04B 1/10

(52) U.S. Cl. 327/551

(57) ABSTRACT

An automatic gain control circuit and method for stably maintaining received power in a mobile Internet system is disclosed. An efficient automatic gain control circuit structure is provided which uses no separate analog circuit elements in a process of detecting the level of a received signal. Therefore, it is possible to reduce a complexity of hardware, the size of the automatic gain control circuit and a manufacturing cost. Further, an automatic gain control (AGC) unit, which is made in a Fluctuating Gunn-Peterson Approximation (FGPA) type, performs an automatic gain control simply by referring to a lookup table based on the level of a received signal. Therefore, the present automatic gain control circuit can not only be more simply designed or modified than a conventional automatic gain control circuit, but also stabilize the level of the received signal simply without periodically checking the level of the received signal for the automatic gain control.

### TECHNICAL FIELD

The present invention relates to an automatic gain control circuit and an automatic gain control method, and more particularly to an automatic gain control circuit and method for stably maintaining received power in a mobile Internet system.

### BACKGROUND ART

A mobile Internet system not only can meet the user s desire to receive an Internet service by a mobile device at high speed any time anywhere, but also has a great ripple effect on the whole field of the domestic information communication industry, so that it is expected to be a promising, new, future industry. Therefore, it is the current reality that the international standardization of the mobile Internet is in progress centering around IEEE 802.16e.

In this mobile Internet system, a signal received by a base station has a wide dynamic range. For this reason, a radio frequency (RF) reception circuit of the base station performs an automatic gain control (AGC) such that the received signal has stable power within a predetermined level range, which will hereinafter be described in detail with reference to FIG. 1.

FIG. 1 is a block diagram showing the configuration of a general RF reception circuit.

As shown in FIG. 1, the RF reception circuit roughly includes an AGC unit 110 for stabilizing a received signal, and an RF receiver 130 for receiving an RF signal.

The AGC unit 110 includes a coupler 111 for extracting power of a received signal, a level detector 113 for detecting the level of an output signal from the coupler 111, a first analog/digital converter (ADC) 115 for analog/digital (A/D)-converting an output signal from the level detector 113, a buffer 117 for temporarily storing the A/D-converted signal, and a central processing unit (CPU) 119 for controlling one or more attenuators based on the level of the A/D-converted signal from the buffer 117 to maintain the level of the received signal constant.

The RF receiver 130 includes a first amplifier 131 for amplifying the power-extracted signal from the coupler 111, a first attenuator 132 for adjusting an attenuation level for the amplified signal under the control of the CPU 119, a mixer 134 for converting an output signal from the first attenuator 132 into an intermediate frequency (IF) signal using a phase locked loop (PLL) 133, a second amplifier 135 for again amplifying the IF signal from the mixer 134, a second attenuator 136 for adjusting an attenuation level for the amplified IF signal under the control of the CPU 119, and a second ADC 137 for A/D-converting an output signal from the second attenuator 136.

A more detailed description will hereinafter be given of the operation of an automatic gain control circuit in the RF reception circuit with the above-stated configuration.

First, the coupler 111 extracts power of a received signal and outputs the resulting power signal to the level detector 113. At this time, the level of the output signal from the coupler 111 varies with the level of the received signal.

The level detector 113 detects the output signal from the coupler 111 to output the signal as type of direct current (DC) voltage level. At this time, the level of the output DC level signal from the level detector 113 varies with the level of the received signal. The output DC level signal from the level detector 113 is converted into a digital signal by the first ADC 115 and then inputted to the CPU 119 through the buffer 117.

Then, the CPU 119 checks the DC level of the signal inputted from the buffer 117 and adjusts the attenuation value of the first attenuator 132 or second attenuator 136 based on the checked DC level to maintain the level of the received signal constant.

That is, in the conventional automatic gain control circuit, the RF stage converts a received RF signal into a DC level signal using the level detector 113 and first ADC 115, and the CPU 119 then checks the level of the DC level signal and controls the first attenuator 132 or second attenuator 136 based on the checked level to perform an automatic gain control.

However, this automatic gain control circuit is disadvantageous in that the level detector 113 and first ADC 115 are used on the RF path, resulting in a complexity in circuit configuration, a waste of space and an increase in cost.

In addition, in the conventional automatic gain control circuit, in order to stabilize the level of a received signal, the CPU 119 must periodically check the DC level of the received signal and control the first attenuator 132 of the RF stage or the second attenuator 136 of the IF stage based on the checked DC level. For this reason, as well as communicating with a host, the CPU 119 must function to periodically check the level of an input signal and control the first attenuator 132 or second attenuator 136 based on the checked level, thus wasting programs and resources.

### DISCLOSURE OF INVENTION

### Technical Problem

Therefore, the present invention has been made in view of the above problems, and it is an object of the present invention to provide an automatic gain control circuit and method which can solve a waste of space and a complexity in circuit construction resulting from analog circuit elements to promote a cost reduction.

It is another object of the present invention to provide an automatic gain control circuit and method which can stabilize power of a received signal rapidly and simply without periodically checking the level of the received signal for an automatic gain control.

### Technical Solution

In accordance with an aspect of the present invention, the above and other objects can be accomplished by the provision of an automatic gain control circuit for a mobile Internet system comprising: a first attenuator for attenuating a received radio frequency (RF) signal; a mixer for converting an output signal from the first attenuator into an intermediate frequency (IF) signal using a phase locked loop (PLL); an amplifier for amplifying the IF signal; a second attenuator for attenuating the amplified IF signal; an analog/digital converter (ADC) for analog/digital (A/D)-converting an output signal from the second attenuator; and an automatic gain control (AGC) unit for obtaining an attenuation value based on the A/D-converted signal using a lookup table and outputting the obtained attenuation value to the first attenuator and second attenuator.

In accordance with another aspect of the present invention, there is provided an automatic gain control circuit for a mobile Internet system comprising: an RF reception circuit comprising a mixer for converting a received RF signal into an IF signal using a PLL, an amplifier for amplifying the IF signal, a IF attenuator for attenuating the amplified IF signal, and an ADC for converting an output signal from the IF attenuator into a digital signal; and a down converter for receiving the digital signal from the RF reception circuit and controlling a gain of the RF reception circuit by referring to a lookup table for an automatic gain control based on a level of the received digital signal.

In accordance with another aspect of the present invention, there is provided an automatic gain control method comprising: (a) attenuating a received RF signal based on a first attenuation value; (b) converting the attenuated RF signal into an IF signal; (c) amplifying the IF signal and attenuating the amplified IF signal based on a second attenuation value; (d) converting the attenuated IF signal into a digital signal and squaring the digital signal to calculate a power value thereof; (e) adjusting the first and the second attenuation value with reference to an attenuation value in a lookup table for an automatic gain control, corresponding to the power value; and (f) attenuating the received RF signal and the amplified IF signal based on the adjusted first attenuation value and second attenuation value, respectively.

In accordance with yet another aspect of the present invention, there is provided an automatic gain control method comprising: (a) receiving an RF signal; (b) attenuating the received RF signal based on a first attenuation value; (c) converting the attenuated RF signal into a digital signal and squaring the digital signal to calculate a power value thereof; and (d) attenuating the received RF signal based on a second attenuation value in a lookup table for an automatic gain control, corresponding to the power value.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a general RF reception circuit;

FIG. 2 is a block diagram showing the configuration of an RF reception circuit to which an automatic gain control circuit according to the present invention is applied;

FIG. 3 is a view showing a lookup table for an automatic gain control according to the present invention;

FIG. 4 is a block diagram showing the configuration of a base station according to one embodiment of the present invention;

FIG. 5 is a waveform diagram illustrating an automatic gain control function of a base station according to one embodiment of the present invention; and

FIG. 6 is a flowchart illustrating an automatic gain control method according to one embodiment of the present invention.

### BEST MODE FOR CARRYING OUT THE INVENTION

Reference will now be made in detail to the preferred embodiments of the present invention, examples of which are illustrated in the accompanying drawings.

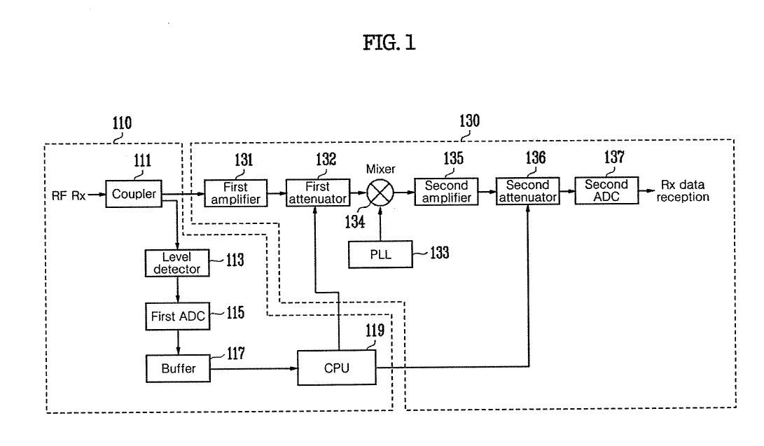

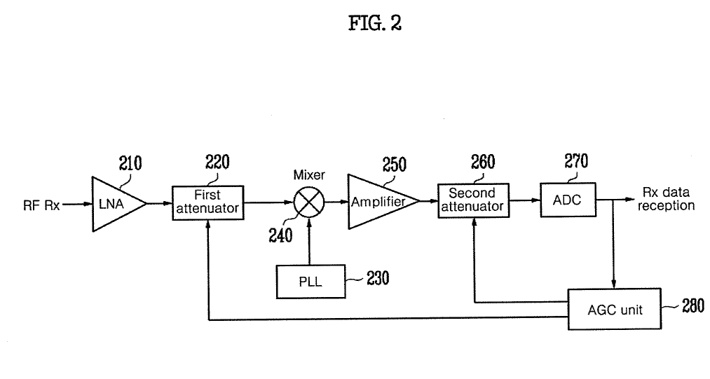

FIG. 2 is a block diagram showing the configuration of an RF reception circuit to which an automatic gain control circuit according to the present invention is applied. A detailed description of blocks in FIG. 2 performing the same functions as those in FIG. 1 will be omitted because it is duplicated, and only blocks performing different functions will hereinafter be described in detail.

As shown in FIG. 2, the RF reception circuit to which the automatic gain control circuit according to the present invention is applied includes a low-noise amplifier (LNA) 210 for receiving an RF signal and reducing a noise component of the entire RF reception stage, a first attenuator 220 for attenuating an output signal from the low-noise amplifier 210 under control of an AGC unit 280 to be described later, a mixer 240 for converting an output signal from the first attenuator 220 into an IF signal using a PLL 230, an amplifier 250 for amplifying the IF signal, a second attenuator 260 for attenuating the amplified IF signal under the control of the AGC unit 280, and an ADC 270 for A/D-converting an output signal from the second attenuator 260. The AGC unit 280 acts to adjust the strength of the received RF signal by referring to a lookup table to be described later, based on the level of the A/D-converted signal.

The low-noise amplifier 210 reduces a noise component of an RF signal inputted to the RF reception circuit to reduce a noise component of the entire RF reception circuit. That is, the low-noise amplifier 210 functions to reduce the noise component of the entire RF reception circuit based on a principle that the total noise factor significantly depends on the initial noise component, as in the following equation 1:

[Equation 1]

F=F1+(F2−1)/G1+(F31)/G1G2+ (1)

where F is the total noise factor, Fn is the noise factor of each stage, and Gn is the gain of each stage.

The first attenuator 220 is operated under the control of the AGC unit 280 at an RF stage and the second attenuator 260 is operated under the control of the AGC unit 280 at an IF stage. As a result, the first attenuator 220 may include one or more attenuators provided at the RF stage and the second attenuator 260 may include one or more attenuators provided at the IF stage.

The AGC unit 280 outputs an attenuation value based on the level of the A/D-converted IF signal from the ADC 270 to the first attenuator 220 and second attenuator 260 with reference to the lookup table. The lookup table may be provided in the AGC unit 280 or stored in a memory (not shown) separately from the AGC unit 280.

A description will hereinafter be given of an automatic gain control method according to the present invention based on the RF reception circuit with the above-stated configuration.

First, an RF signal received by the RF reception circuit is inputted to the mixer 240 through the low-noise amplifier 210 and first attenuator 220. The mixer 240 mixes the inputted signal with an output signal from the PLL 230 and outputs an IF signal as a result of the mixing.

This IF signal is inputted to the ADC 270 through the amplifier 250 and second attenuator 260. At this time, the IF signal may be filtered for emphasis on a signal component thereof before being inputted to the amplifier 250.

The IF signal inputted to the ADC 270 is converted into a digital IF signal through A/D conversion. This digital IF signal is inputted to the AGC unit 280 so as to be used to control the strength of the RF signal received by the RF reception circuit, as will hereinafter be described in detail.

Power of the digital IF signal inputted to the AGC unit 28 can be expressed as in the following equation 2:

[Equation 2]

P=V²/R[W] (2)

Here, because R=1 in the digital signal, P=V².

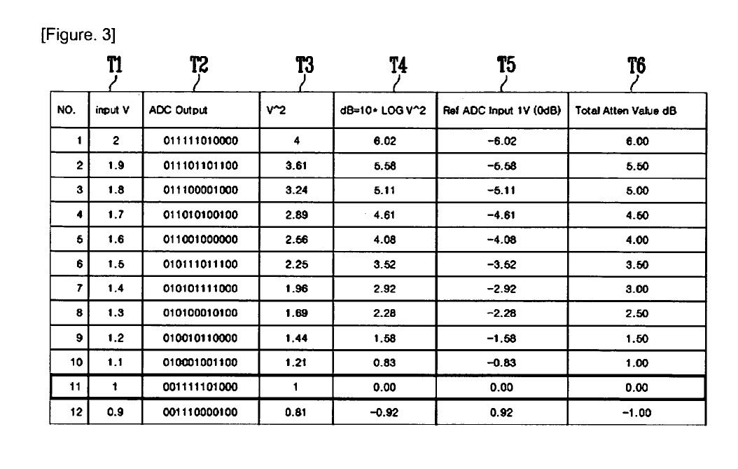

That is, the AGC unit 280 squares the inputted digital IF signal to obtain the power value of the digital IF signal and controls the first attenuator 220 and the second attenuator 260 by referring to the lookup table for the automatic gain control based on the obtained power value. The lookup table will hereinafter be described in detail with reference to FIG. 3.

FIG. 3 shows the lookup table for the automatic gain control according to the present invention.

Referring to FIG. 3, in the lookup table is recorded an input voltage value T1 to the ADC 270, an output value T2 of the ADC 270 corresponding to the input voltage value T1, a power value T3 corresponding to the output value T2 of the ADC 270, a value T4 into which the power value T3 is converted in a dB unit, a relative dB power value T5 corresponding to the input voltage value T1 to the ADC 270, and an attenuation value T6 of the dB unit to be compensated for through the first attenuator 220 and the second attenuator 260. In the case of the attenuation value, a negative sign (−) represents compensation and a positive sign (+) represents attenuation.

For example, assuming that the ADC 270 performs sampling on a 12-bit basis, the input analog IF signal is divided into about 4000 (accurately, 2¹²=4096) levels. At this time, assuming that one symbol is composed of 12 bits, only 40 symbols and then some can be used to constitute the lookup table as shown in FIG. 3 in consideration of a data processing speed, an efficiency and a gain control of the first attenuator 220 and second attenuator 260.

According to the lookup table configured as shown in FIG. 3, the attenuation value for the first attenuator 220 and second attenuator 260 can be controlled within the range of −20 to 6 dB depending on the level of a signal inputted to the ADC 270, and adjusted up/down about 0.5 dB by 0.5 dB.

Here, the reason why the gain control unit of the attenuation value is 0.5 dB is to consider the fact that the gain step of the attenuator is generally 0.5 dB, and the reason why the power value is converted in the dB unit is to facilitate the up/down calculation of the attenuation value.

On the other hand, the gain control for the attenuation value for the first attenuator 220 and second attenuator 260 can be done within the range of 0 to 30 dB depending on the level of an input signal. Because the attenuation value for the first attenuator 220 and second attenuator 260 has a gain variation width of −20 to 6 dB in the lookup table of FIG. 3, it is preferably set to the intermediate value of the variation width, 26/2 =13 dB, in the initial operation so that the level of a signal inputted to the ADC 270 can become +/−1V in the end.

In this manner, according to the automatic gain control circuit and method of the present invention, the AGC unit 280 can simply control the first attenuator 220 and the second attenuator 260 by referring to the lookup table based on the level of an input signal. In particular, provided that this AGC unit 280 is made in a Fluctuating Gunn-Peterson Approximation (FGPA) type, it is possible to implement an automatic gain control circuit which is more efficient in terms of space and circuit configuration.

### EMBODIMENTS

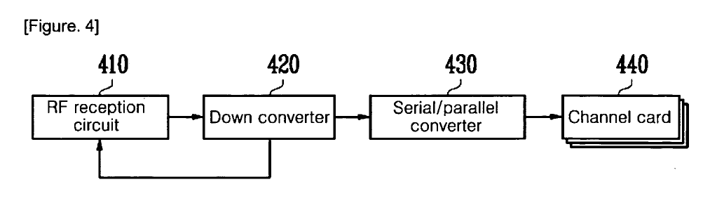

FIG. 4 is a block diagram showing the configuration of a base station according to one embodiment of the present invention.

As shown in FIG. 4, the base station according to this embodiment includes an RF reception circuit 410, a down converter 420 for down-converting a digital IF signal outputted from the RF reception circuit 410 and controlling the gain of the RF reception circuit 410, a plurality of channel cards 440 for wirelessly communicating with mobile terminals, and a serial/parallel converter 430 for serial/parallel-converting an output signal from the down converter 420 and transmitting the converted signal to the channel cards 440.

The RF reception circuit 410 includes all the constituent elements of FIG. 2 other than the AGC unit 280. That is, the RF reception circuit 410 low-noise amplifies a received RF signal, controls the strength of the low-noise amplified signal, converts the strength-controlled signal into an IF signal, amplifies the converted IF signal and controls the strength of the amplified IF signal. Thereafter, the RF reception circuit 410 A/D-converts the strength-controlled IF signal and outputs the resulting digital IF signal to the down converter 420.

In the present embodiment, the strength of the received signal is controlled by the down converter 420 downstream from the RF reception circuit 410, although it has been shown in FIG. 2 to be controlled by the AGC unit 280.

That is, the down converter 420 receives the digital IF signal from the RF reception circuit 410, controls the gain of the RF reception circuit 410 by referring to a lookup table based on the level of the received digital IF signal, down-converts the gain-controlled digital IF signal into a signal of the original frequency band and outputs the resulting signal to the serial/parallel converter 430.

In the present embodiment, the lookup table is preferably configured to adjust an attenuation value up/down about 0.5 dB by 0.5 dB within the range of −20 to 6 dB depending on the level of a signal inputted to the down converter 420, in the same manner as the lookup table of FIG. 3.

As described above, in the base station according to one embodiment of the present invention, the RF reception circuit 410 can detect the level of a received signal without using a separate level detector and a separate ADC, thereby reducing a complexity of hardware and an occupation area. Further, the automatic gain control can be simply performed by referring to the lookup table based on the detected level of the received signal. Therefore, it is possible to stabilize the level of the signal received by the base station rapidly and simply without periodically checking the level of the received signal for the automatic gain control.

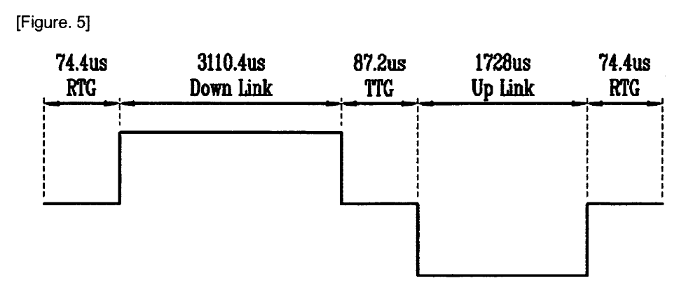

On the other hand, it is preferable that the automatic gain control function as stated above is performed during only an uplink period of the base station, as will hereinafter be described in detail with reference to FIG. 5.

FIG. 5 is a waveform diagram illustrating an automatic gain control function of a base station according to one embodiment of the present invention.

Referring to FIG. 5, in a mobile Internet system using a Time Division Duplex

(TDD) mode, generally, a base station transmits a signal to a mobile terminal during a downlink period and receives a signal from the mobile terminal during an uplink period.

That is, during the downlink period, only a noise component exists on an RF path and the level of a received signal is also very low. Provided that the above-stated automatic gain control function is performed in the downlink period, the down converter 420 will recognize that a signal of low power is received by the RF reception circuit 410, and thus set the attenuation value for the attenuators to ‘0’ (see FIG. 2), thereby causing a signal of suddenly increased power to be inputted to the amplifier and ADC. If such a signal of high power exceeding an input threshold is inputted to the amplifier and ADC, then the possibility that, due to saturation of these elements, the quality of the received signal will be degraded or the respective elements will be deteriorated is high. For this reason, it is preferable that the above-stated automatic gain control function is performed during only the uplink period of the base station.

Hereinafter, an automatic gain control method according to one embodiment of the present invention will be described in detail with reference to the annexed drawing.

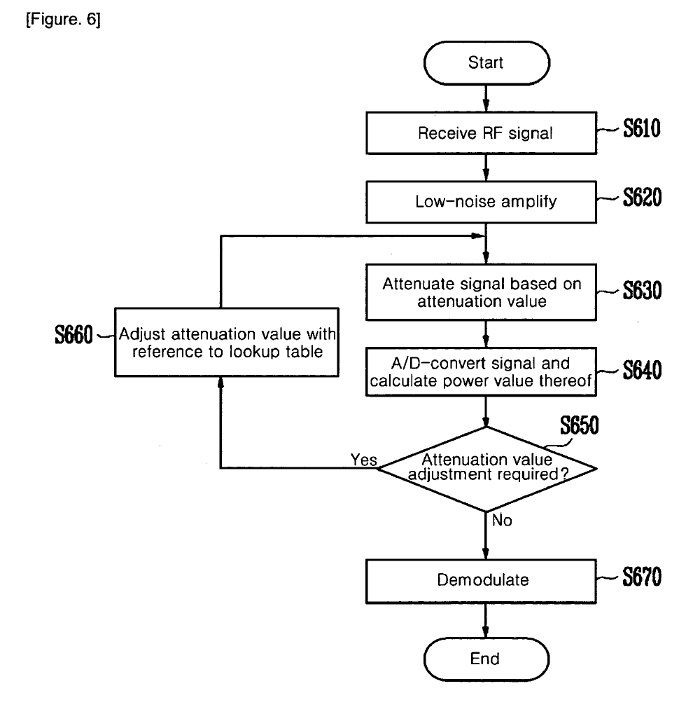

FIG. 6 is a flowchart illustrating an automatic gain control method according to one embodiment of the present invention, which is carried out by a base station to which the automatic gain control circuit as shown in FIG. 4 is applied.

First, when an RF signal is received (S610), the base station low-noise amplifies the received RF signal to reduce a noise component thereof (S620). The noise component reduction by this low-noise amplification has been described in detail in association with the above equation 1 and a detailed description thereof will thus be omitted.

Thereafter, the base station attenuates the low-noise amplified signal based on an attenuation value such that the received RF signal has stable power within a predetermined range (S630). At this time, the attenuation value can be adjusted through a process to be described later.

Subsequently, the base station converts the attenuated signal into a digital signal through A/D conversion and squares the converted digital signal to calculate the power value thereof (S640).

Then, the base station determines whether to adjust the attenuation value by referring to a lookup table based on the power value of the digital signal (S650).

Here, in the lookup table is recorded an attenuation value (dB unit) to be compensated for based on the level of an input digital signal. In the present invention, the lookup table is configured to adjust the attenuation value up/down 0.5 dB by 0.5 dB within the range of −20 to 6 dB depending on the level of an input digital signal. The lookup table configured in this manner has been described in detail with reference to FIG. 3 and a detailed description thereof will thus be omitted.

If it is determined that the attenuation value must be adjusted, the base station adjusts the attenuation value with reference to the lookup table (S660), again attenuates the low-noise amplified signal based on the adjusted attenuation value and then returns to step S630 to repeat it and the subsequent steps.

On the other hand, in the case where it is determined that the attenuation value does not need to be adjusted, the base station demodulates the digital signal and outputs the demodulated signal (S670).

In this manner, according to the automatic gain control method of the present invention, the automatic gain control can be simply performed by referring to the lookup table based on the level of the received signal. Therefore, the present method is advantageous over a conventional method in that it is possible to stabilize the level of the received signal without periodically checking the level of the received signal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As apparent from the above description, the present invention provides an efficient automatic gain control circuit structure which uses no separate analog circuit elements in a process of detecting the level of a received signal. Therefore, it is possible to reduce a complexity of hardware, the size of an automatic gain control circuit and a manufacturing cost.

Further, according to the present invention, an AGC unit for an automatic gain control is made in an FGPA type, thereby making it possible to implement an automatic gain control circuit which not only can be more simply designed or modified than a conventional automatic gain control circuit, but also is more efficient in terms of space and circuit configuration than the conventional automatic gain control circuit.

Furthermore, according to the present invention, an automatic gain control can be simply performed by referring to a lookup table based on the level of a received signal. Therefore, it is possible to stabilize the level of the received signal rapidly and simply without periodically checking the level of the received signal for the automatic gain control.

1. An automatic gain control circuit for a mobile Internet system comprising:
a first attenuator for attenuating a received radio frequency (RF) signal;
a mixer for converting an output signal from the first attenuator into an intermediate frequency (IF) signal using a phase locked loop (PLL);
an amplifier for amplifying the IF signal;
a second attenuator for attenuating the amplified IF signal;
an analog/digital converter (ADC) fr analog/digital (A/D)-converting an output signal from the second attenuator; and
an automatic gain control (AGC) unit for obtaining an attenuation value based on the A/D-converted signal using a lookup table and outputting the obtained attenuation value to the first attenuator and second attenuator.

2. The automatic gain control circuit according to claim 1, further comprising a low-noise amplifier for reducing a noise component of the received RF signal and outputting the resulting signal to the first attenuator.

3. The automatic gain control circuit according to claim 1, wherein the first attenuator and the second attenuator comprises each one or more attenuators.

4. The automatic gain control circuit according to claim 1, wherein the lookup table comprises an input voltage value to the ADC, a relative dB power value corresponding to the input voltage value, and the attenuation value of a dB unit to be compensated for through the first attenuator and the second attenuator.

5. The automatic gain control circuit according to claim 4, wherein the lookup table further comprises an output value of the ADC corresponding to the input voltage value, a power value corresponding to the output value of the ADC, and a value into which the power value is converted in the dB unit.

6. The automatic gain control circuit according to claim 4, wherein the attenuation value is adjusted up/down 0.5 dB by 0.5 dB within a range of −20 to 6 dB.

7. The automatic gain control circuit according to claim 1, wherein the AGC unit squares the A/D-converted signal to obtain a power value thereof and outputs an attenuation value included in the lookup table corresponding to the obtained power value to the first attenuator and second attenuator.

8. The automatic gain control circuit according to claim 1, wherein the AGC unit is implemented in a Fluctuating Gunn-Peterson Approximation (FGPA) type.

9. The automatic gain control circuit according to claim 1, wherein the AGC unit performs an automatic gain control during an uplink period.

10. An automatic gain control circuit for a mobile Internet system comprising:
an RF reception circuit comprising a mixer for converting a received RF signal into an IF signal using a PLL, an amplifier for amplifying the IF signal, a IF attenuator for attenuating the amplified IF signal, and an ADC for converting an output signal from the IF attenuator into a digital signal; and
a down converter for receiving the digital signal from the RF reception circuit and controlling a gain of the RF reception circuit by referring to a lookup table based on a level of the received digital signal.

11. The automatic gain control circuit according to claim 10, wherein the RF reception circuit further includes a RF attenuator for attenuating the received RF signal and outputting the resulting signal to the mixer.

12. The automatic gain control circuit according to claim 11, wherein the lookup table comprises an input voltage value to the ADC, an output value of the ADC corresponding to the input voltage value, a power value corresponding to the output value of the ADC, a value into which the power value is converted in a dB unit, a relative dB power value corresponding to the input voltage value to the ADC, and an attenuation value of the dB unit to be compensated for through the IF attenuator and the RF attenuator.

13. The automatic gain control circuit according to claim 10, wherein the down converter down-converts the digital signal from the RF reception circuit into a signal of an original frequency band.

14. The automatic gain control circuit according to claim 11, wherein the down converter outputs an attenuation value comprised in the lookup table corresponding to a power value of the digital signal to the IF attenuator and the RF attenuator.

15. An automatic gain control method comprising:
(a) attenuating a received RF signal based on a first attenuation value:
(b) converting the attenuated RF signal into an IF signal;
(c) amplifying the IF signal and attenuating the amplified IF signal based on a second attenuation value;
(d) converting the attenuated IF signal into a digital signal and squaring the digital signal to calculate a power value thereof;
(e) adjusting the first and the second attenuation value with reference to an attenuation value in a lookup table for an automatic gain control, corresponding to the power value; and
(f) attenuating the received RF signal and the amplified IF signal based on the adjusted first attenuation value and second attenuation value, respectively.

16. The automatic gain control method according to claim 15, further comprising, before the step(a), low-noise amplifying the received RF signal.

17. The automatic gain control method according to claim 15, wherein the lookup table comprises the power value of the digital signal and the attenuation value of a dB unit to be compensated for based on the power value.

18. The automatic gain control method according to claim 15, wherein the step(e) further comprises adjusting the first attenuation value and the second attenuation value up/down 0.5 dB by 0.5 dB within a range of −20 to 6 dB based on the power value.

19. The automatic gain control method according to claim 15, further comprising, before the step(a), controlling the first attenuation value and the second attenuation value such that the power value of the digital signal is 1.

20. An automatic gain control method comprising:
(a) receiving an RF signal;
(b) attenuating the received RF signal based on a first attenuation value;
(c) converting the attenuated RF signal into a digital signal and squaring the digital signal to calculate a power value thereof; and
(d) attenuating the received RF signal based on a second attenuation value in a lookup table for an automatic gain control, corresponding to the power value.

21. The automatic gain control method according to claim 20, further comprising, before the step (a), low-noise amplifying the received RF signal.

22. The automatic gain control method according to claim 20, wherein the lookup table comprises the power value of the digital signal and the second attenuation value of a dB unit to be compensated for based on the power value.

23. The automatic gain control method according to claim 20, wherein the step (d) further comprises adjusting the second attenuation value up/down 0.5 dB by 0.5 dB within a range of −20 to 6 dB based on the second attenuation value in the lookup table corresponding to the power value.
